(19) United States
(12) Patent Application Publication
(10) Pub. No.: US 2026/0242965 A1
(43) Pub. Date: Aug. 20, 2026

(54) ELECTROCHEMICAL CELL STACK

(71) Applicant: Schaeffler Technologies AG & Co. KG, Herzogenaurach (DE)

(72) Inventors: Matthias Frank, München (DE); Josef Hauck, Nürnberg (DE); Timo Woehner, Nürnberg (DE); Yuan Yao, Herzogenaurach (DE)

(73) Assignee: Schaeffler Technologies AG & Co. KG, Herzogenaurach (DE)

(21) Appl. No.: 19/161,713

(22) PCT Filed: Feb. 16, 2024
(86) PCT No.: PCT/DE2024/100127

§ 371 Date: Sep. 3, 2025

(30) Foreign Application Priority Data
Mar. 3, 2023 (DE) 10 2023 105 253.5
Feb. 15, 2024 (DE) 10 2024 104 248.6

(51) Int. Cl. C25B 9/75; C25B 9/77; C25B 11/032; C25B 13/02

(52) U.S. Cl. CPC C25B 9/75; C25B 9/77; C25B 11/032; C25B 13/02

(57) ABSTRACT

An electrochemical cell stack includes a plurality of cells separated from one another by bipolar plates. Each cell is formed from two half-cells between which a membrane is arranged. The support frame describes a stepped shape with two adjacent cross-section regions. An edge of the membrane lies in a step formed by the cross-section regions and the porous transport layer of a half-cell extends into the step. The support frame includes at least one sealing arrangement and an electrically insulating sealing material. The sealing arrangement includes three sealing regions each having at least one sealing lip. A first sealing region and a second sealing region are assigned to the narrower of the two cross-section regions facing the membrane. A third sealing region on a side of the support frame facing away from the step and borders an opening of the support frame.

### CROSS-REFERENCE TO RELATED APPLICATIONS

This application is the United States National Phase of International Application PCT/DE2024/100127, filed Feb. 16, 2024, which claims priority to German Application 10 2024 104 248.6, filed Feb. 15, 2024 and German Application 10 2023 253.5, filed Mar. 3, 2023. The disclosures of the above applications are incorporated herein by reference.

### TECHNICAL FIELD

The disclosure relates to an electrochemical cell stack including a plurality of electrochemical cells which are separated from one another by bipolar plates. Each electrochemical cell is formed from two half-cells between which a membrane surrounded by a support frame is arranged. A porous transport layer is disposed in each half-cell. The electrochemical cell stack is designed in the form of a stack of electrolytic cells for hydrogen production.

### BACKGROUND

An electrolytic cell stack is known, for example, from WO 2018/078157 A1. The known electrolytic cell stack, i.e. electrolyzer, includes a plurality of bipolar plates arranged in stack form, with membranes and porous transport layers, which are generally also referred to as porous transport layers (PTL), being disposed between the bipolar plates. According to WO 2018/078157 A1, the bipolar plates each have a layer of Ir, Ru, Rh, Os, their oxides or mixtures thereof. This layer is intended to act as a corrosion protection layer within the electrochemical system.

DE 10 2021 203 983 A1 discloses a single-cell arrangement for a fuel cell stack. In this case, a framed membrane electrode arrangement includes an electrochemically active region consisting of two gas diffusion layers and a catalyst-coated membrane, which are adhesively bonded to a frame. Furthermore, the arrangement according to DE 10 2021 203 983 A1 includes a bipolar plate which has flow distribution and conduction elements in a flow region corresponding to the electrochemically active region. In an edge region of the bipolar plate surrounding the flow region, a sealing groove is formed on at least one of the surfaces of the bipolar plate to accommodate a seal between the frame and the bipolar plate.

A further membrane assembly which separates an anode space from a cathode space within a fuel cell stack is described in DE 10 2009 039 905 A1. The membrane of the arrangement according to DE 10 2009 039 905 A1 has an elongated rectangular shape, with a plurality of channels, generally also referred to as ports, for the passage of working gases, i.e. operating media, being located on both narrow sides of the rectangular membrane. The membrane belongs to an MEA plate, which is surrounded by an installation aid portion that is designed as a dimensionally stable support frame. Within a connecting portion which connects the MEA plate to the support frame there is a seal designed as a sealing bead.

An arrangement for a fuel cell disclosed in DE 10 2008 028 117 A1 includes a bipolar plate in the form of a flat component to which a sealing element is form-fittingly attached. The sealing element is substantially U-shaped.

Further design options for seals in stacked arrangements of electrochemical cells can be found, for example, in documents EP 3 039 734 B1, DE 10 2006 058 335 A1, DE 11 2015 002 427 T5 and WO 2021/104812A1.

EP 3 356 575 B1 discloses a high-pressure or differential pressure electrolytic cell which has an electrochemical cell with a high-pressure side and a low-pressure side. The electrochemical cell has two flow field plates and a membrane which is arranged between the flow field plates and has a first side on the low-pressure side and a second side on the high-pressure side. Furthermore, the electrolyzer according to EP 3 356 575 B1 includes a first porous support which is arranged between the first side of the membrane and the first flow field plate and -compared to other materials arranged between the plates-is relatively incompressible. A first seal surrounds the first porous support, a gap being formed between the first porous support and the seal. A second seal is arranged between the second side of the membrane and the second flow field plate. Furthermore, the device according to EP 3 356 575 B1 includes a second porous support which is arranged on the second side of the membrane and which is more compressible than the first porous support. The electrolyzer according to EP 3 356 575 B1 should be operable at a pressure difference between the high-pressure side and the low-pressure side of at least 40 bar.

DE 10 2022 101 106 A1 describes an electrolytic cell having a cell frame made of insulating plastic between two bipolar plates. At least one sealing element in the form of a flat seal is provided between the cell frame and each bipolar plate. The flat seal is integrated into the cell frame using a 2K injection molding process.

### SUMMARY

The disclosure provides an electrochemical cell stack which has been further developed with respect to the aforementioned prior art, in particular with regard to manufacturing and sealing aspects, for example in the form of a stack of electrolytic cells for hydrogen production, where the cell stack should also be operable under a high differential pressure between the cathode side and the anode side.

One aspect of the disclosure provides an electrochemical cell stack, such as a stack of electrolytic cells for hydrogen production. The cell stack includes a plurality of electrochemical cells, which are separated from one another by bipolar plates, in a basic concept known per se, each electrochemical cell being formed from two half-cells, between which a membrane surrounded by a support frame is arranged, and a porous transport layer permeable to operating media of the electrochemical system being disposed in each half-cell.

In some examples, the support frame has a stepped shape in cross-section, with there being two mutually bordering, for example rectangular, cross-section regions of the support frame of different widths. In general, mutually adjoining regions of different widths are concerned. The width of these mutually distinguishable regions must be measured in the plane in which the support frame and the membrane lie. One edge of the membrane rests on the support frame in a step formed by the two cross-section regions.

The porous transport layer of one of the two half-cells of the electrochemical cell is designed as a compressive-force-transmitting element and extends from the active field of the electrochemical cell enclosed by the support frame into the aforementioned step, i.e. beyond the inner edge of the support frame. The compressive forces under consideration are forces that act in a normal direction with respect to the parallel planes in which the support frames and the bipolar plates are arranged.

The support frame includes at least one sealing arrangement injection-molded onto the support frame and made of an electrically insulating sealing material, the sealing arrangement includes at least three sealing regions, each having at least one sealing lip, namely a first sealing region and a second thin sealing region, which belong to the narrower cross-section region facing the membrane. The thickness of all sealing regions must be measured in the normal direction mentioned, i.e. orthogonal to the direction in which the width of the various cross-section regions of the support frame is to be measured. Each of the two sealing regions mentioned contacts exactly one bipolar plate. Furthermore, there is a third sealing region, which is disposed on a side of the support frame facing away from the step, i.e. on the outer side of the support frame, and borders an opening, i.e. a port, of the support frame provided for the guiding through of media and contacts both bipolar plates against which the first sealing region and the second sealing region bear.

The at least three sealing regions are integral components of the support frame and, viewed from the active field of the electrochemical cell, are staggered from the inside outwards, with the first sealing region sealing off the cathode side of the electrochemical cell and constituting the innermost seal, i.e. the one closest to the center of the active field. Consequently, the active field has a smaller outline on the cathode side than on the anode side. The membrane of the electrochemical cell rests on the first sealing region. In contrast to non-claimed solutions, the membrane is not supported at this point by another seal. In fact, a volume portion of the porous transport layer on the anode side is disposed on the side of the membrane directly opposite the first sealing region on the cathode side. This volume portion belongs to the element already mentioned, which is suitable for transmitting compressive forces. From this element, which is in the form of a porous transport layer, the compressive forces can be transmitted further into the adjoining bipolar plate.

Just like the membrane, the anode-side porous transport layer, which is designed to transmit compressive forces, also extends into the step which is formed by the two cross-section regions of the support frame of different widths. A strip-like edge region of the membrane is therefore disposed in a region that can hardly be used anymore for electrochemical reactions. The mechanical support of the edge region of the membrane by a similarly strip-like region of the support frame makes a significant contribution to preventing leaks from occurring at the corresponding point, for example by pressing the membrane into a gap at its edge. Rather, the strip-like edge region of the membrane is also pressed against the step by the pressure prevalent on the anode side.

The active field of the electrochemical cell is limited on the anode side by the second sealing region further outward. The anode-side porous transport layer can extend up to this second sealing region, and this second sealing region together with other volume portions of the support frame can be used in addition to the transport layer to transmit compressive forces acting between the bipolar plates.

The third sealing region encloses the outer edge of the support frame on the side facing away from the step. The third region has at least two sealing lips that run against the bipolar plate arranged above and below the support frame in the cross-section of the support frame.

The sealing material is formed from an elastomeric material which has a Shore A hardness of 70-90 ShA, such as at a temperature of 23° C.±2 K. The Shore A hardness is specified for elastomers after measurement with a needle with a blunt tip. The end face of the truncated cone has a diameter of 0.79 millimeters and the opening angle is 35°. Support weight: 1 kg, holding time: 15 s. The material thickness should be at least 6 mm.

Examples of sealing materials suitable for forming the various sealing regions are FKM (used as an abbreviation for fluororubber compound or fluorocarbon rubber) and EPDM (ethylene propylene diene rubber). Known technologies such as injection molding and edge bonding are suitable for applying the sealing material.

In principle, the minimum required seal overlap, i.e. the height of a sealing lip above the remaining sealing region, is a function or the result of material hardness, design, the tolerance chain and system requirements, i.e. the pressure to be sealed in a half-cell. In principle, the seal overlap is a multiple of the height of any existing support structures; see below.

In some implementations, both the first sealing region and the third sealing region, at their ends facing away from the support frame, each have at least two annular sealing lips running parallel to the plane of the membrane, and the second sealing region has at least one sealing lip running in an annular manner parallel to the plane of the membrane. Possible designs of the sealing lips are shown in FIGS. 12 and 13.

A sealing region may be designed—viewed in cross-section through the frame arrangement—to be almost as high as it is wide. The sealing region thus resembles an O-ring. The sealing function of the second sealing region is primarily based on axial compression of the sealing lip(s). The sealing function of the first and third sealing regions is primarily based on an axial compression of the sealing lips and a pressure activation, which acts primarily horizontally on the sealing region and is applied by the medium to be sealed, and which leads to an additional axial sealing force on the sealing lips due to the preferably low compressibility of the sealing material.

The various sealing regions are generally made up of incompressible substances, such as elastomers. This results in interactions between loads acting in different directions, for example horizontal forces arising in the plane of the support frame and vertical forces acting in the longitudinal direction of the stack, i.e. the cell stack. Such interactions increase the sealing effect of the support frame. Overall, the support frame is a highly integrated component that is embedded in a compact, easy-to-install, robust cell design. Owing to the integration of various functions in the support frame and the resulting minimized number of individual components, the issue of assembly tolerances has been largely eliminated by design.

The support frame, which in plane view has at least three sealing regions offset from one another, is suitable for use in an electrolyzer, for example, which is operated with a pressure difference of 100 bar between the cathode side and the anode side. A particular advantage of this application is that separate equipment for compressing the hydrogen in order to feed it into a pipeline network or directly to a consumer can be largely or even completely dispensed with.

Apart from the sealing regions, metallic or non-metallic materials are generally suitable for manufacturing the support frame. If a core of the support frame is made of metal, a substance on the core can provide electrical insulation between the two bipolar plates that enclose the support frame between them.

It has proven useful if there is at least one electrically insulating region which connects the third sealing region to the second sealing region and/or the second sealing region to the first sealing region. The at least one electrically insulating region has no sealing function, but merely serves as electrical insulation. This may be necessary on the anode side, the cathode side or both sides of the support frame.

The at least one electrically insulating region may be formed from the electrically insulating sealing material from which the sealing arrangement is made. The electrically insulating region can be formed during the formation of the sealing arrangement. This electrically insulating region can be realized both in a support frame with a metallic core and in a support frame made entirely of non-metallic materials. In some examples, however, the at least one electrically insulating region is arranged on a support frame made of electrically conductive material in order to reduce costs.

In some implementations, elastic support in the electrically insulating region, which is significantly wider than any of the sealing regions, is supported by elastic support structures, such as elastic nubs, projections, grooves or compression springs. The support structures can be made of any metallic and/or non-metallic materials.

The elastic flexibility of the support structures can be used for installation with a so-called soft stop. It is assumed here that the support frame, including the electrically insulating region, is a softer spring than the arrangement in the active field, which in addition to the membrane also includes the porous transport layers in the two half-cells.

A hard-stop concept, on the other hand, can be realized with a support frame that does not have an electrically insulating region made of an elastic material such as the sealing material. In such a case, the adjacent bipolar plates can rest directly on the barely flexible core of the support frame, provided the core is made of an electrically insulating material. Otherwise, electrical insulation can be provided by an electrically insulating coating, which is disposed on at least one side of the support frame which bears against a bipolar plate, as an electrically insulating region. Ceramic coatings, such as those made of Al₂O₃ and/or SiO₂ or polymer coatings are suitable as electrically insulating coatings.

If a core element of the support frame is designed as a metal part, such as a sheet metal part, a single or multi-layer design of this core element is possible. In the case of a two-layer design, one of the two sheet metal layers of the core element in the region of its end face can form the step with a longer sheet metal layer arranged underneath. The sheet metal layers can be joined together by welding, for example.

If the support frame is made of sheet metal, such as sheet steel, a three-dimensional structure of the sheet metal provides advantages in terms of mechanical stability while using less material. For example, the metal core of the support frame, which is made from sheet metal using forming processes, has a three-dimensionally formed cross-section. Beads introduced in the sheet metal can run in the longitudinal direction of the frame. After forming the sheet metal, which is the core element of the support frame, the sheet metal can be overmolded with an elastomer, which forms all the sealing regions, in a single work step. At the same time, electrically insulating regions can be injection-molded on.

In some implementations, the first sealing region is disposed between one of the two bipolar plates, which sandwich the support frame, and a layered arrangement intended to absorb compressive forces. The specified arrangement is formed of the membrane of the electrochemical cell, the porous transport layer of the anode-side half-cell that transmits compressive force, the second bipolar plate and a cooling field frame that is mechanically more resilient than the surrounding elements. Despite the low height of the electrochemical cells, a stable structure of the entire cell stack with highly effective seals both inside the cells and to the outside can be realized.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a detail of an exemplary electrochemical cell stack viewed in cross-section;

FIG. 2 shows a detail from the arrangement according to FIG. 1;

FIG. 3 shows a support frame of the cell stack according to FIG. 1 in plan view;

FIGS. 4-10 show details of further electrochemical cell stacks viewed in cross-section;

FIG. 11 shows a further detail of an electrochemical cell stack, viewed in cross-section;

FIGS. 12-13 show possible sealing lips for the sealing regions viewed in cross-section.

Like reference symbols in the various drawings indicate like elements.

### DETAILED DESCRIPTION

Unless otherwise stated, the following explanations relate to all the exemplary embodiments. Parts that correspond to each other or have basically the same effect are denoted with the same reference signs in all the figures.

An electrochemical cell stack identified overall by the reference sign 1 is an electrolyzer for producing hydrogen. The cell stack 1 includes a plurality of electrochemical cells 2, i.e. electrolytic cells, which are each composed of a first half-cell 3 and a second half-cell 4. Bipolar plates 5, 5′ separate a half-cell 3 of a first electrochemical cell 2 from a half-cell 4 of a further electrochemical cell 2. The two half-cells 3, 4 of each electrochemical cell 2 are separated from one another by a membrane 6. The membrane 6 is disposed in a support frame 7, which is sandwiched between two mutually parallel bipolar plates 5, 5′.

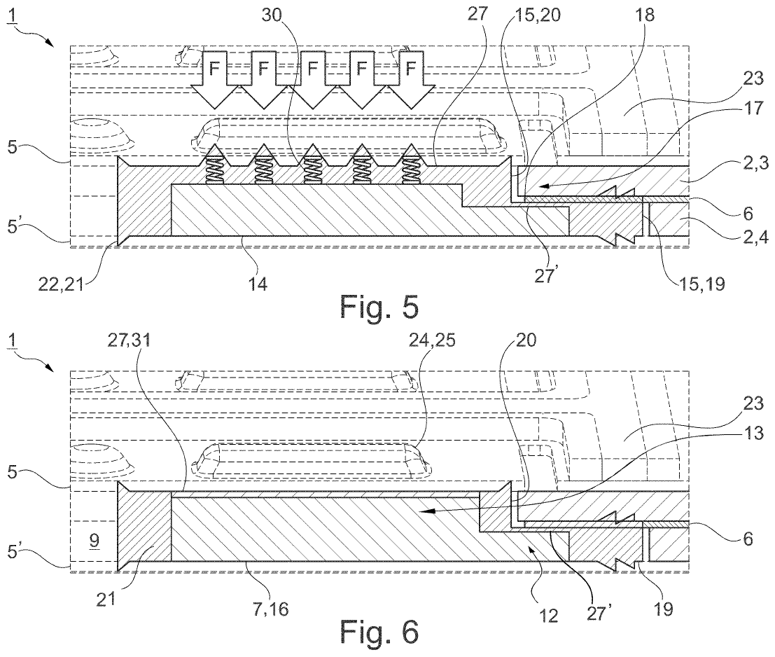

The outline of the support frame 7 is shown in FIG. 3. The support frame 7 encloses an active field 8 of the electrolytic cell 2. Openings 9 which are arranged outside the active field 8 and through which operating media of the cell stack 1 are guided are generally referred to as ports. Within the electrolytic cells 2, the operating media flow, among other things, through porous transport layers 10, 11 disposed in the half-cells 3, 4. As can be seen in all the figures except FIG. 3, the two half-cells 3, 4 are of different widths. Without limiting the generality, in the present cases the anode-side half-cell 3 is referred to as the upper half-cell and the cathode-side half-cell 4 as the lower half-cell. In all cases, the anode-side porous transport layer 10 protrudes over the cathode-side porous transport layer 11. Therefore, the support frame 7 enclosing the active field 8 has a stepped shape in cross-section.

The portion of the support frame 7 considered in the borders, on one side, a port 9 and, on the other side, the two half-cells 3, 4 of the same electrochemical cell 2. In the aforementioned portion, there are two mutually distinguishable cross-section regions 12, 13 of different widths. The support frame 7 includes a single-or multi-part core element 14, which occupies space in at least one of the cross-section regions 12, 13, as well as a sealing arrangement denoted by 15. Like the core element 14, the sealing arrangement 15 belongs to a frame portion 16.

The width of the frame portion 16 to be measured in the plane of the support frame 7 is denoted by BR. The smaller width of the core element 14 in all cases is denoted by BK. The height of the support frame 7, denoted by HR, together with further elements of the cell stack 1, determines the distance between two adjacent bipolar plates 5, 5′. The sum of the thickness of the cross-section region 13 and the thickness of the electrically insulating region 27 gives the height HR of the frame portion 16. In these cases too, the indications “bottom” and “top” refer only to the figures and do not imply any assertion about the actual installation position of the components 5, 5′, 6, 16 in the cell stack 1.

A step 17 is formed between the cross-section region 12 and the cross-section region 13 on the side of the frame portion 16 facing the active field 8. An edge of the membrane 6 denoted by 18 is located in this step 17, and it remains at least slightly spaced from the core element 14 due to the presence of the sealing arrangement 15. The sealing arrangement 15 includes three mutually distinguishable sealing regions 19, 20, 21. A first sealing region 19 and a second sealing region 20 can be distinguished from the third sealing region 21. The thickness of the first sealing region 19 and of the second sealing region 20 in each case corresponds to the height of a half-cell 3, 4. The third sealing region 21 fills the entire height of the cell. While the latter third sealing region 21 seals towards the port 9, the two sealing regions 19, 20 seal the active field 8. All sealing regions 19, 20, 21 are integral components of the support frame 7. In some examples, each sealing region 19, 20, 21 has at least one sealing lip 22. The sealing lips 22 shown in the sectional view of the membrane 6 each run in an annular manner when viewed from above.

As shown, the first sealing region 19 has two sealing lips 22, which rest on the lower bipolar plate 5′, and two further sealing lips 22, on which the membrane 6 rests. The total of four sealing lips 22 are directed against the pressure acting during operation of the cell stack 1, which increases the sealing effect with increasing pressure. The shape of the sealing lips 22 thus contributes to the self-sealing effect.

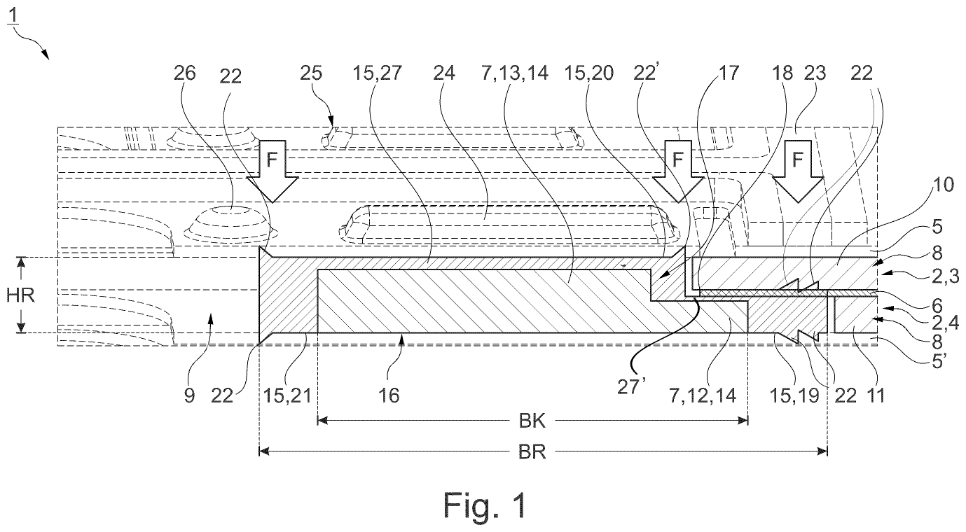

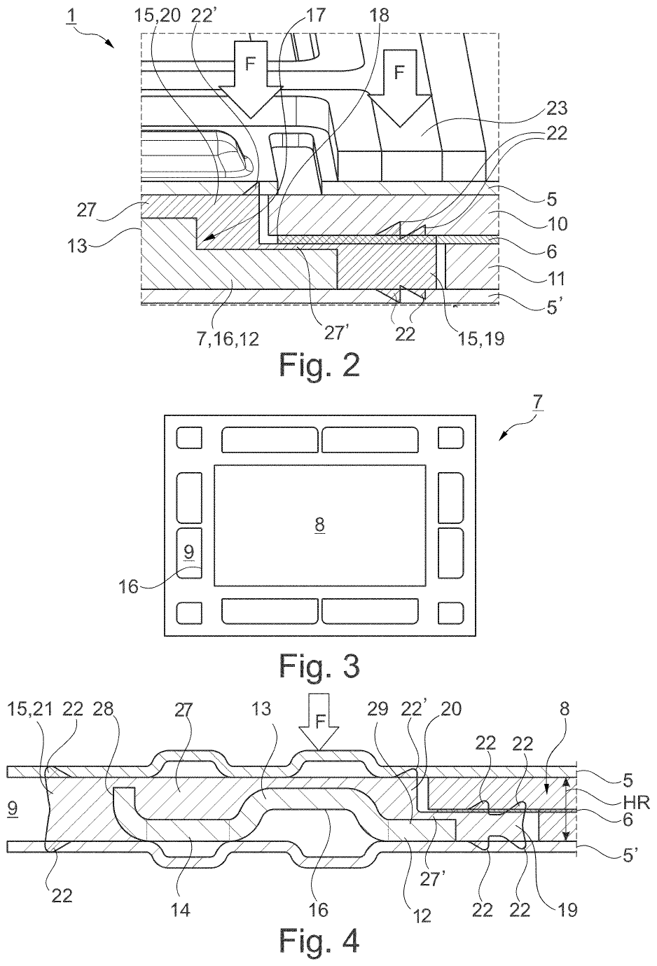

The porous transport layer 10 disposed above the membrane 6 constitutes a force-transmitting element which, together with the first sealing region 19, transmits forces F, i.e. compressive forces, between the bipolar plates 5, 5′ that are arranged parallel to each other. FIGS. 1 and 2 illustrate a force effect on a cooling field frame 23, which is inserted into an embossed structure of the bipolar plate 5 denoted by 25. Elongated or circular embossed elements of the embossed structure 25 are denoted by 24, 26.

In some implementations, the second sealing region 20 has only a single sealing lip 22 which bears against the bipolar plate 5. Viewed from the active field 8, the second sealing region 20 is offset outwards, i.e. in the direction of the port 9, from the first sealing region 19. In the examples shown, the third sealing region 21 directly bordering the port 9 has exactly two sealing lips 22, each of the sealing lips 22 contacting one of the bipolar plates 5, 5′, between which the support frame 7 is arranged.

As shown in FIGS. 1, 2, 4, 5, 6, 7, 8, 9, there is also an electrically insulating region 27 which connects the second sealing region 20 to the third sealing region 21 and bears against the upper bipolar plate 5, which can be seen in the illustrations. The sealing regions 20, 21 and the electrically insulating region 27 thus extend over the entire cross-section region 13 in these cases.

According to FIGS. 1, 2, 4, 5, 7, 8, 9, there is a further electrically insulating region 27′ which connects the second sealing region 20 to the first sealing region 19.

According to FIGS. 1, 2, 4, 5, 7, 8 and 9, the electrically insulating regions 27, 27′ are formed from the electrically insulating sealing material with which the sealing regions 19, 20, 21 are formed.

According to FIG. 6, an electrically insulating region 27 is formed from an electrically insulating coating 31 which does not correspond to the sealing material.

This gives the entire support frame 7 elastic flexibility in the normal direction of the plane in which the support frame 7 lies.

As shown in FIGS. 1 and 2, the core element 14 of the support frame 7 is made of plastic. The sealing arrangement 15 is connected integrally to the core element 14 so that the support frame 7, which includes the core element 14 and the sealing arrangement 15, forms a structural unit that is not intended for disassembly.

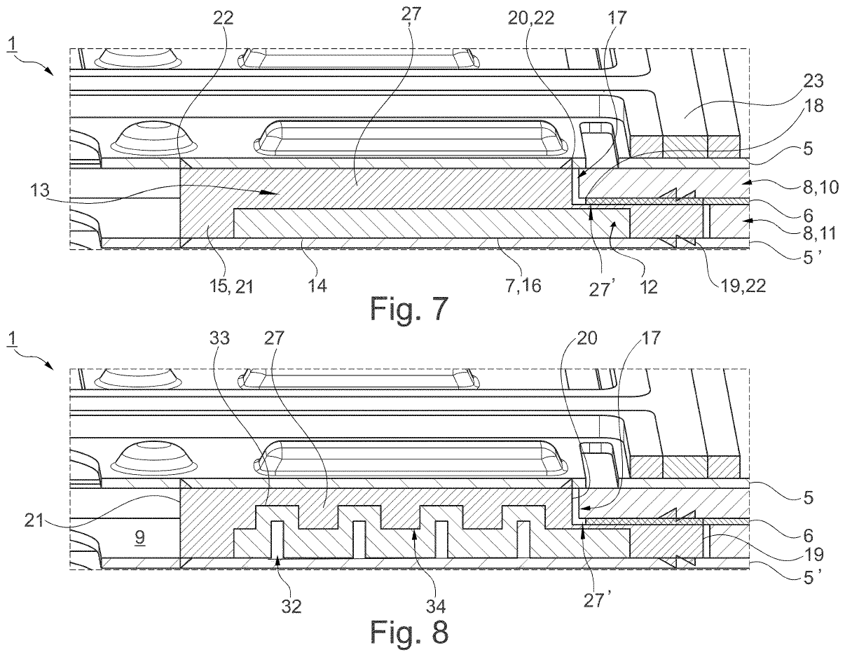

Such a structural unit consisting of the core element 14 and the sealing arrangement 15 is also present in the design shown in FIG. 4, and in this case the core element 14 is designed as a profiled metal sheet onto which the sealing arrangement 15 is injection-molded. As far as the shape of the individual sealing regions 19, 20, 21 and the number of sealing lips 22 are concerned, there are no fundamental differences between the example shown in FIG. 4 and the example shown in FIG. 1. In the case of FIG. 4, the core element 14, which is designed as a metal sheet, rests on the lower bipolar plate 5′ in a plurality of strip-like regions. On the left-hand side of the core element 14 in the arrangement shown in FIG. 4, i.e. the side facing the port 9, an edge bar 28 is formed by the core element 14 and protrudes from the plane that is tangent to the lower bipolar plate 5′ on the one hand and the underside of the core element 14 on the other hand, and extends approximately over the entire height HR of the support frame 7. On the opposite, inner side of the core element 14, this runs out in the form of a flat band 29, which is adjoined by the first sealing region 19 in the direction of the active field 8.

The support frame 7 shown in FIG. 5 differs from the support frame 7 shown in FIGS. 1 and 2 in that a plurality of elastic support elements 30, here compression springs indicated as helical springs, are disposed in the electrically insulating region 27, which support elements transmit forces F, as illustrated by arrows in FIG. 5, between the bipolar plate 5 and the support frame 7. In the case of FIG. 5, as in the case of FIG. 1, the core element 14 is made of plastic.

In the design shown in FIG. 6, the core element 14 is made of metal and is therefore designed as an electrical conductor. To create electrical insulation between the parallel bipolar plates 5, 5′, which sandwich the support frame 7 between them, there is an electrically insulating region 27 in the form of an electrically insulating coating 31 on the upper side of the support frame 7, i.e. on the cross-section region 13. Elastic deformability of the support frame 7 in the normal direction of the bipolar plates 5, 5′ is much less pronounced in the case of FIG. 6 than in the cases of FIGS. 1, 4 and 5. Therefore, FIG. 6 is referred to as a hard-stop concept.

In the case of FIG. 7, the support frame 7 has the same outer shape as is shown in FIG. 1. In contrast to FIG. 1, in the case of FIG. 7 the cross-section region 13 is formed by a part of the core element 14 and the electrically insulating region 27. The core element 14 is also disposed in the cross-section region 12. As shown in FIG. 7, a pronounced soft-stop concept is thus realized.

As shown in FIG. 8, the core element 14 is made of metal, as in the case of FIG. 4. The core element 14 has a tooth profile produced by forming, with grooves 32, i.e. beads, running in the longitudinal direction on the underside of the profile and rectangular teeth 33 in cross-section on the upper side of the profile being visible. In order to match the cross-section of the core element 14, the fourth sealing region 27 has a toothed structure 34, which is not visible from the outside and which provides a particularly stable bond between the core element 14 and the sealing arrangement 15.

A metallic core element 14 is also included in FIG. 9, although in this case it is formed from two sheet metal strips 35, 36 of unequal width which are welded together. The entire cross-sectional shape of the core element 14 of the support frame 7 shown in FIG. 9 corresponds to the example shown in FIG. 1.

As shown in FIG. 10, the plastic core element 14 fills the entire height HR between the two bipolar plates 5. In this case, the sealing arrangement 15 only includes the two interconnected sealing regions 19, 20 and the separate sealing region 21.

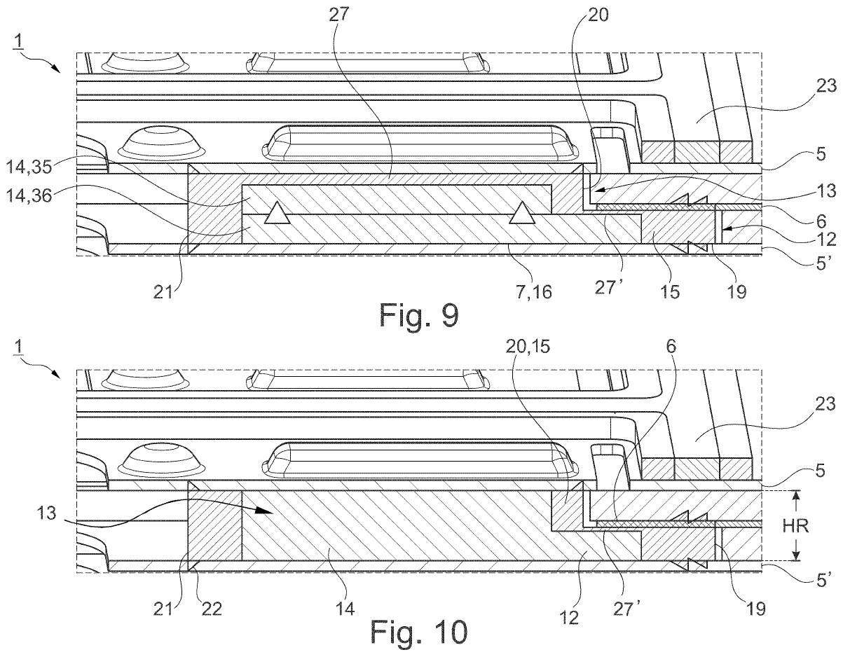

According to FIG. 11, there is a core element 14 and a sealing arrangement 15, and in this case the core element 14 is designed as a profiled metal sheet, onto which the sealing arrangement 15 is injection-molded. As far as the shape of the individual sealing regions 19, 20, 21 and the number of sealing lips 22 are concerned, there are no fundamental differences between the example shown in FIG. 4 and the example shown in FIG. 1. The same reference signs in these figures indicate identical elements. Only the core element 14 is more filigree in the cross-section region 13 and forms a step 17 with the cross-section region 12 due to the forming of the metal sheet. The electrically insulating region 27 between the third sealing region 21 and the second sealing region 20 has support structures 30, which support the bipolar plate 5. Like the electrically insulating region 27, the further electrically insulating region 27′ between the second sealing region 20 and the first sealing region 19 is formed from sealing material and is injection-molded in one piece, and at the same time as the sealing arrangement 15, onto the core element 14. The frame arrangement 16 is particularly inexpensive and quick to manufacture.

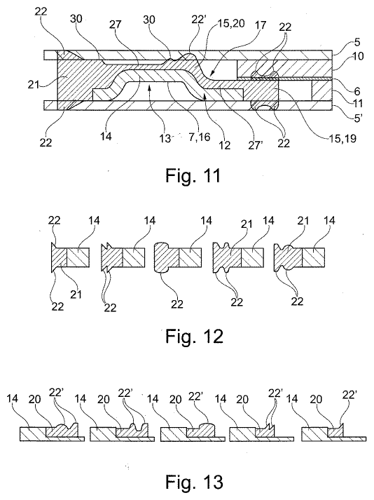

FIG. 12 shows possible designs of sealing lips 22 in the third region 21, which is injection-molded onto an end face of a core element 14 that is only partially shown. Seen here from left to right are:
two sealing lips 22, each with a triangular basic shape;
four sealing lips 22, each with a triangular basic shape;
two sealing lips 22, each with a round basic shape;
four sealing lips 22, each with a stepped, flattened basic shape;
four sealing lips 22, two each with a triangular basic shape, two with a round basic shape.

Such basic shapes can be combined as required, and the number of sealing lips 22 can be varied. The sealing lip designs shown for the third sealing region 21 can also be used for the first sealing region 19.

FIG. 13 shows possible designs of a sealing lip 22′ in the second region 20 which is injection-molded in the region of the step 17 of a core element 14 that is only partially shown. Seen here from left to right are:
two sealing lips 22′, one with a round basic shape and one with a triangular basic shape;
two sealing lips 22′, each with a stepped, flattened basic shape;
one sealing lip 22′ with a round basic shape;
two sealing lips 22′, each with a triangular basic shape;
one sealing lip 22′ with a triangular basic shape.
   Such basic shapes can be combined as desired and the number of sealing lips 22′ can be varied.

A number of implementations have been described. Nevertheless, it will be understood that various modifications may be made without departing from the spirit and scope of the disclosure. Accordingly, other implementations are within the scope of the following claims.

### REFERENCE NUMERALS

1 Electrochemical cell stack
2 Electrochemical cell, electrolytic cell
3 Half-cell
4 Half-cell
5,5′ Bipolar plate
6 Membrane
7 Support frame
8 Active field
9 Opening, port
10 Porous transport layer, anode side
11 Porous transport layer, cathode side
12 Cross-section region
13 Cross-section region
14 Core element
15 Sealing arrangement made of sealing material
16 Frame portion
17 Step
18 Edge of membrane
19 First sealing region on active field with sealing lips 22
20 Second sealing region on active field with one-sided sealing lip 22′
21 Third sealing region, bordering port 9
22 Sealing lip
22′ Sealing lip
23 Cooling field frame
24 Embossed element
25 Embossed structure
26 Embossed element
27, 27′ Electrically insulating region (without sealing function)
28 Edge bar
29 Band
30 Support structures
31 Electrically insulating coating
32 Groove
33 Tooth
34 Toothed structure
35 Sheet metal strip
36 Sheet metal strip
BR Width of the frame element
BK Width of the core element
F Compressive force
HR Height of the support frame

1. An electrochemical cell stack comprising:
bipolar plates;
a plurality of electrochemical cells separated from one another by the bipolar plates, each electrochemical cell includes two half-cells, a membrane, and a support frame, the membrane is surrounded by the support frame and arranged between the two half-cells,
a porous transport layer is disposed in each half-cell,
wherein the support frame, viewed in cross-section, includes a stepped shape having at least two mutually adjoining cross-section regions of different widths, one edge of the membrane lying in a step formed by the two cross-section regions, and the porous transport layer of one of the two half-cells extending as a compressive-force-transmitting element into the step, and
wherein the support frame comprises at least one sealing arrangement of an electrically insulating sealing material injection-molded onto the support frame, the at least one sealing arrangement comprising at least three sealing regions each having at least one sealing lip, the at least three sealing regions include a first sealing region and a second sealing region, which belong to the narrower of the two cross-section regions facing the membrane and each contact exactly one bipolar plate, and a third sealing region, which is disposed on a side of the support frame facing away from the step and borders an opening of the support frame for guiding through of media and in this case contacts the bipolar plates against which the first and second sealing regions bear.

2. The cell stack of claim 1, wherein at least one electrically insulating region is present, which connects the third sealing region to the second sealing region and/or the second sealing region to the first sealing region.

3. The cell stack of claim 2, wherein the at least one electrically insulating region is formed from the sealing material or an electrically insulating coating.

4. The cell stack of claim 2, further comprising a plurality of elastic support structures arranged in the at least one electrically insulating region.

5. The cell stack of claim 1, further comprising a core element of the support frame made of plastic.

6. The cell stack of claim 1, further comprising a core element of the support frame being a sheet metal part.

7. The cell stack of claim 6, wherein the support frame is built in two layers from the sheet metal part.

8. The cell stack of claim 6, wherein both the first sealing region and the third sealing region, at their ends facing away from the support frame, each have at least two annular sealing lips running parallel to a plane of the membrane, and in that the second sealing region has at least one sealing lip running in an annular manner parallel to the plane of the membrane.

9. The cell stack of claim 6, wherein the support frame has a core element in the form of a metal part formed three-dimensionally from a flat sheet metal strip.

10. The cell stack of claim 1, wherein the first sealing region lies between one of the bipolar plates and a layered arrangement which is formed from the membrane, the porous transport layer provided for transmitting compressive force, the further bipolar plate and a cooling field frame.
